(19) United States
(12) Patent Application Publication
(10) Pub. No.: US 2010/0193699 A1
(43) Pub. Date: Aug. 5, 2010

(54) Radiography network system and radiographic image capturing system control method

(75) Inventors: Masato Hattori, Minami-ashigara-shi (JP); Keiji Tsubota, Minami-ashigara-shi (JP); Yutaka Yoshida, Tokyo (JP); Yasunori Ohta, Yokohama-shi (JP); Naoyuki Nishino, Minami-ashigara-shi (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/656,620

(22) Filed: Feb. 4, 2010

(30) Foreign Application Priority Data
Feb. 5, 2009 (JP) 2009-024424

(51) Int. Cl. G01T 1/161; G01T 1/00

(52) U.S. Cl. 250/394

(57) ABSTRACT

An image capturing apparatus establishes a communication link with one console and transmits obtained radiographic image information to the one console. The one console includes a backup unit therein. The backup unit includes means (network monitoring unit, backup data storage unit) for monitoring a network, reading the radiographic image information during transmission thereof via the network, and temporarily storing the read radiographic image information as backup data, and means (supplementary data extraction unit, supplementary data transmitter) for transmitting to another console as supplementary data a portion or all of the backup data, in accordance with a data supplementing request from the other console.

### CROSS-REFERENCE TO RELATED APPLICATION

This application is based upon and claims the benefit of priority from Patent Application No. 2009-024424 filed on Feb. 5, 2009, in the Japan Patent Office, of which the contents are incorporated herein by reference.

### BACKGROUND OF THE INVENTION

1. Field of the Invention

The present invention relates to a radiography network system, which is equipped with a radiographic image capturing system having a plurality of image capturing apparatus and a plurality of controllers, the plurality of image capturing apparatus and the plurality of controllers being interconnected over a wireless network, as well as to a radiographic image capturing system control method.

2. Description of the Related Art

In the medical field, there have widely been used image capturing apparatus that apply radiation to a subject and guide radiation that has passed through the subject to a radiation detector, which captures a radiographic image from the radiation.

One known radiation detector is a stimulable phosphor panel, which stores radiation energy representative of a radiographic image in a phosphor. When the stimulable phosphor panel is irradiated with stimulating light, the phosphor emits stimulated light representing the stored radiographic image. The stimulable phosphor panel, with the radiographic image recorded therein, is supplied to an image reading apparatus, which reads the stored radiographic image as a visible radiographic image.

Further, in a treatment location such as an operating room or the like, in order to enable processing to be quickly and reliably carried out with respect to a subject (patient), it has been demanded that radiographic image information from a radiation detector be immediately read out and displayed. As a radiation detector capable of meeting this requirement, a radiation detector has been developed that uses solid state image sensors for converting radiation directly into electric signals, or by which, after the radiation has been converted into visible light by a scintillator, the visible light is converted into electric signals, which in turn are read out.

Heretofore, there has been proposed a radiographic image capturing system including a plurality of radiation detectors, which are connected by a network to a plurality of consoles for controlling the radiation detectors and processing radiographic image information detected by the radiation detectors (see, for example, Japanese Laid-Open Patent Publication No. 2006-247137 and Japanese Laid-Open Patent Publication No. 2006-247141). In the proposed radiographic image capturing system, a radiation detector to be used and a console are selected with a keyboard input and are associated with each other on the network. More specifically, the radiation detector is controlled by the corresponding console, and radiographic image information produced by the radiation detector in a radiographic image capturing process is sent to the console via the network.

However, in such a conventional type of radiographic image capturing system, when the radiographic image information is sent to a corresponding console from a selected radiation detector, due to changes and the like in the communication environment between the radiation detector and the console, cases occur in which data is lost. In particular, when data is transmitted wirelessly, and in cases where a radiation source or other obstacles come to be moved and pass between the console and the radiation detector, it is easy for loss of data to occur.

In data that is highly correlated such as radiographic image information, with respect to random errors in which errors are generated independently and sporadically, error corrections can be carried out responsive to such errors using the values of pixels in the vicinity thereof. However, in the case that loss of data occurs over a wide area, as in the case of burst errors, a problem occurs in that correction of such errors cannot be made.

In the case of loss of data to such a degree that error corrections cannot be made, a method could be contemplated whereby a retransmission request is performed with respect to the radiation detector, so as to obtain transmission of the radiographic image information once again. However, in the case of capturing a tomosynthesis image, in which capturing of radiation is carried out in succession over tens of times, since a memory is used efficiently to reduce power consumption and lower costs, a case exists in which a storage method is utilized in which the next radiographic image information overwrites any existing radiographic image information after transmission of the radiation image has been completed. In this type of situation, a request to retransmit the data cannot be handled. Of course, even in the case of one-shot radiography, in the event that a retransmission request is considered, it is necessary for the radiographic image information recorded in the radiation detector to be retained for a long time period, which causes problems in that the usage efficiency of the radiation detector deteriorates excessively, and battery consumption increases.

Further, a technique exists in which a plurality of external memory devices (e.g., hard disks) are connected with respect to a single controller and mirroring is carried out thereby. However, ultimately, since the radiographic image information, in which data loss may have occurred due to the transmission process, is simply recorded in such plural external memory devices, such a technique does not serve as an effective backup.

### SUMMARY OF THE INVENTION

The present invention has been devised while taking into consideration the aforementioned problems. It is an object of the present invention to provide a radiography network system, as well as a radiographic image capturing system control method, in which, even in the event that data loss occurs as a result of a data transmission process for the radiographic image information, supplementing of the data can easily be performed, and in addition, without requiring a memory means to be newly installed especially for backup purposes, high quality radiographic image information can be obtained at a low cost.

A radiography network system according to a first aspect of the present invention is equipped with a radiographic image capturing system having at least a plurality of image capturing apparatus for detecting radiation that has passed through a subject in a radiographic image capturing and converting the radiation into radiographic image information, and a plurality of controllers for controlling the image capturing apparatus based on image capture command information supplied from the exterior, at least the plurality of image capturing apparatus and the plurality of controllers of the radiographic image capturing system being interconnected over a wireless network. A portion or all of the plurality of image capturing apparatus each include, respectively, a communication device for establishing a communication link with one of the controllers from among the plurality of controllers and transmitting the obtained radiographic image information to the one controller. The plurality of controllers each include, respectively, a backup unit therein, which is operated in the event that the communication link is not established. The backup unit comprises a unit for monitoring the network, reading the radiographic image information during transmission thereof via the network, and temporarily storing the read radiographic image information as backup data, together with a unit for transmitting a portion or all of the backup data to the one controller as supplementary data in accordance with a data supplementing request from the one controller.

In the first aspect of the invention, the backup unit may further include a network monitoring unit for monitoring the network and reading the radiographic image information during transmission thereof via the network, a storage unit for temporarily storing the read radiographic image information in a memory as backup data, a supplementary data extracting unit for extracting as supplementary data all of the backup data, or an object part of the data supplementing request from among the backup data that is stored in the memory, based on the data supplementing request from the one controller, and a transmitting unit for transmitting the extracted supplementary data to the one controller.

In the first aspect of the invention, the radiographic image capturing system may further comprise a plurality of image capturing apparatus, which each utilize a radiation detector for detecting radiation that has passed through a subject in a radiographic image capturing and converting the radiation into radiographic image information, and a plurality of controllers for controlling the image capturing apparatus based on image capture command information supplied from the exterior, wherein the plurality of image capturing apparatus and the plurality of controllers are interconnected by a wireless network, and wherein the plurality of image capturing apparatus each include the communication device therein, respectively.

In the first aspect of the invention, the radiographic image capturing system may further comprise at least one first image capturing apparatus utilizing a radiation detector that detects radiation having passed through a subject in a radiographic image capturing and converts the radiation into radiographic image information, at least one second image capturing apparatus utilizing a stimulable phosphor panel that detects radiation having passed through a subject in a radiographic image capturing, converts the radiation into radiographic image information and stores the radiographic image information therein, at least one image reading apparatus for reading the radiographic image information from the stimulable phosphor panel, and a plurality of controllers for controlling any of the first image capturing apparatus, the second image capturing apparatus, and the image reading apparatus based on image capture command information supplied from the exterior. The at least one first image capturing apparatus, the at least one second image capturing apparatus, the at least one image reading apparatus, and the plurality of controllers are interconnected over a wireless network, wherein each of the at least one first image capturing apparatus includes the communication device therein, respectively, and each of the plurality of controllers and the at least one image reading apparatus includes the backup unit therein, respectively.

In the first aspect of the invention, the communication device may further comprise a unit for transmitting a first request signal for requesting image processing to the plurality of controllers, prior to transmission of the radiographic image information, a unit for selecting one controller from among one or more controllers that transmit a first answer signal in response to the first request signal, a unit for transmitting a second request signal for requesting establishment of a communication link with respect to the one controller that has been selected, and a unit for transmitting the radiographic image information to the one controller, upon reception of a second answer signal in response to the second request signal transmitted from the one controller, wherein an unselected controller, among the one or more controllers that transmit the first answer signal, is caused to operate the backup unit contained therein.

In the first aspect of the invention, in the case there is data loss in the transmitted radiographic image information, the one controller may indicate an address where the data loss occurred and carry out the data supplementing request, whereas the backup unit may extract, as the supplementary data, all of the backup data or a portion corresponding to the address from among the backup data, and transmit the supplementary data to the one controller.

In the first aspect of the invention, the backup unit may further comprise a data erasing unit for erasing the backup data after transmission of the supplementary data to the one controller.

In the first aspect of the invention, the data erasing unit, after having transmitted the supplementary data to the one controller, may wait for a response from the one controller before erasing the backup data.

In the first aspect of the invention, the data erasing unit, after having transmitted the supplementary data to the one controller, may erase the backup data based on a reception completion response of the supplementary data from the one controller.

In the first aspect of the invention, the data erasing unit, after having transmitted the supplementary data to the one controller, may erase the backup data based on a data supplementing completion response from the one controller.

Further, a radiographic image capturing system control method according to a second aspect of the invention, controls through a wireless network at least a plurality of image capturing apparatus and a plurality of controllers, which constitute a radiographic image capturing system comprising at least the plurality of image capturing apparatus for detecting radiation that has passed through a subject in a radiographic image capturing and converting the radiation into radiographic image information, and the plurality of controllers for controlling the image capturing apparatus based on image capture command information supplied from the exterior, wherein at least the plurality of image capturing apparatus and the plurality of controllers of the radiographic image capturing system are interconnected over the wireless network. The radiographic image capturing system control method includes a step of establishing a communication link between a portion or all of the image capturing apparatus and one of the controllers from among the plurality of controllers, and transmitting the obtained radiographic image information to the one controller, and a step of performing backup processing in the event that the communication link is not established. The backup processing step further includes a step of monitoring the network, reading the radiographic image information during transmission thereof via the network, and temporarily storing the read radiographic image information as backup data, and a step of transmitting a portion or all of the backup data to the one controller as supplementary data in accordance with a data supplementing request from the one controller.

As described above, according to the radiography network system and the radiographic image capturing system control method according to the present invention, even in the event that data loss occurs as a result of a data transmission process for the radiographic image information, supplementing of the data can easily be performed. In addition, without requiring a memory means to be newly installed especially for backup purposes, high quality radiographic image information can be obtained at a low cost.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a structural block diagram showing a first network system;

FIG. 2 is a circuit block diagram showing configuration details of a radiation detector;

FIG. 3 is a block diagram showing configuration details of a communication device in an image capturing apparatus;

FIG. 4 is a block diagram showing configuration details of an image processing system and an error correcting system of a console;

FIG. 5 is a block diagram showing configuration details of a backup processing system of the console;

FIG. 6 is a flowchart of a first processing operation (1) and showing cooperative operations of a host computer, first through third consoles, and an image capturing apparatus (communication device);

FIG. 7 is a flowchart of a second processing operation (2) and showing cooperative operations of the host computer, the first through third consoles, and the image capturing apparatus (communication device);

FIG. 8 is a flowchart of a third processing operation (3) and showing cooperative operations of the host computer, the first through third consoles, and the image capturing apparatus (communication device);

FIG. 9 is a structural block diagram showing a second network system; and

FIG. 10 is a structural diagram showing an image reading apparatus.

### DESCRIPTION OF THE PREFERRED EMBODIMENTS

Like or corresponding parts are denoted by like or corresponding reference characters throughout the views.

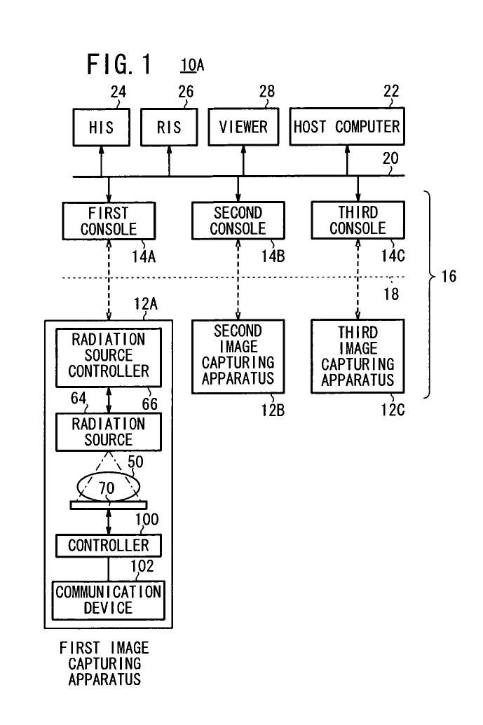

A radiography network system and a radiographic image capturing system control method according to preferred embodiments of the present invention will be described below with reference to FIGS. 1 through 10.

First, as shown in FIG. 1, a radiography network system according to a first embodiment of the present invention (hereinafter referred to as a “first network system 10A”) is equipped with a radiographic image capturing system 16, which comprises three image capturing apparatus (a first image capturing apparatus 12A, a second image capturing apparatus 12B, and a third image capturing apparatus 12C) using radiation detectors, and a plurality of controllers (a first console 14A, a second console 14B, and a third console 14C) for controlling the first through third image capturing apparatus 12A through 12C based on image capture command information supplied from an external source. The first through third consoles 14A through 14C are associated respectively with the first through third image capturing apparatus 12A through 12C. The radiation detectors detect radiation that has passed through a subject in a radiographic image capturing process, and convert the detected radiation into radiographic image information. The first through third image capturing apparatus 12A through 12C and the first through third consoles 14A through 14C are connected to each other by a wireless network, i.e., a wireless LAN 18, indicated by the broken line, which corresponds to a later-described wired network (wired LAN 20). The aforementioned first through third consoles 14A through 14C also are connected to a wired network, i.e., a wired LAN 20, which is connected to a host computer 22 for managing and controlling the first through third consoles 14A through 14C, a hospital information system (HIS) 24 for managing medical information in a hospital, a radiology information system (RIS) 26 for managing processes for capturing radiographic images in the radiological department of the hospital under management of the HIS 24, and a viewer 28 for allowing a doctor to interpret captured radiographic images.

The host computer 22 acquires, via the wired LAN 20, patient information including the name, age, gender, etc., of a patient, which have been set using the HIS 24, and image capture command information including a radiographic image capturing method, a region to be imaged, and an image capturing apparatus to be used for the patient, which have been set by the doctor or a radiological technician using the RIS 26. If necessary, the image capture command information may comprise image capturing conditions including a tube voltage, a tube current, and a radiation applying time, etc., which are to be set in the radiation source of the image capturing apparatus that is used. The host computer 22 supplies the acquired patient information and image capture command information to corresponding ones of the first through third consoles 14A through 14C via the wired LAN 20.

The first image capturing apparatus 12A comprises an upstanding image capturing apparatus or a recumbent image capturing apparatus for capturing a radiographic image of the chest or the like of a subject 50. The first image capturing apparatus 12A comprises a radiation source 64 controlled by a radiation source controller 66, an image capturing base (not shown) housing therein a radiation detector 70 (radiation detecting device), which is made up of solid-state image capturing devices disposed in confronting relation to the radiation source 64, a controller 100 for controlling the radiation detector 70, and a communication device 102 for transmitting radiographic image information obtained by the radiation detector 70 to either one of the first through third consoles 14A through 14C. The radiation source controller 66 controls the radiation source 64 according to image capturing conditions that are set by the first console 14A. The second and third image capturing apparatus 12B and 12C are similar in structure to the first image capturing apparatus 12A, and will not be described in detail below.

The first through third image capturing apparatus 12A through 12C are each positioned and installed at a certain distance away from the first through third consoles 14A through 14C. The distances between the image capturing apparatus and the consoles are defined as follows:

### DEFINITIONS

L11: Distance between the first image capturing apparatus 12A and the first console 14A

L12: Distance between the first image capturing apparatus 12A and the second console 14B

L13: Distance between the first image capturing apparatus 12A and the third console 14C

L22: Distance between the second image capturing apparatus 12B and the second console 14B

L21: Distance between the second image capturing apparatus 12B and the first console 14A

L23: Distance between the second image capturing apparatus 12B and the third console 14C

L33: Distance between the third image capturing apparatus 12C and the third console 14C

L31: Distance between the third image capturing apparatus 12C and the first console 14A

L32: Distance between the third image capturing apparatus 12C and the second console 14B

In this case, a relationship exists in which L11<L12, L11<L13, L22<L21, L22<L23, L33<L31 and L33<L32. For example, by adoption of a distance relationship in which L11, L22 and L33 have lengths ranging from 1 m to 5 m whereas L12, L13, L21, L23, L31 and L32 have lengths ranging from 3 m to 10 m, for example, even if the radiation source or other obstacles are moved and pass between the first image capturing apparatus 12A and the first console 14A, then, for example, there is almost no movement or passage of the radiation source or other obstacles between the first image capturing apparatus 12A and the second console 14B, or between the first image capturing apparatus 12A and the third console 14C. Accordingly, even if the communication environment changes drastically by movement and passage of the radiation source or other obstacles between the first image capturing apparatus 12A and the first console 14A, the communication environment between the first image capturing apparatus 12A and the second console 143, or between the first image capturing apparatus 12A and the third console 14C, hardly is changed at all.

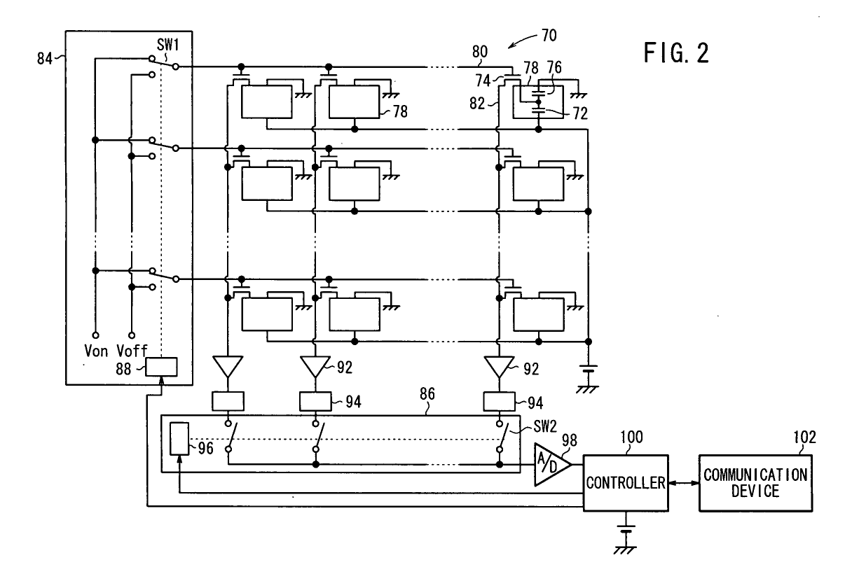

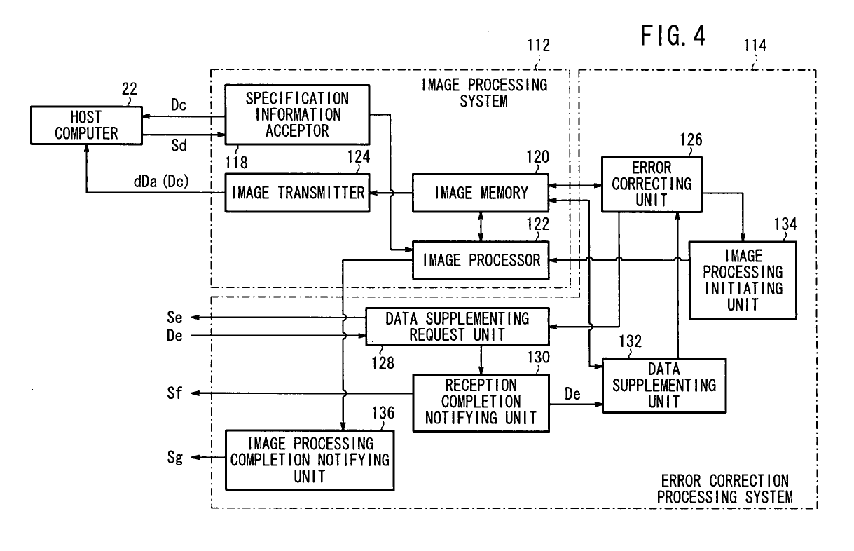

As shown in FIG. 2, the radiation detector 70 comprises an array of thin-film transistors (TFTs) 74 arranged in rows and columns, a photoelectric conversion layer 72 made of a material such as amorphous selenium (a-Se) for generating electric charges upon detection of radiation, the photoelectric conversion layer 72 being disposed on the array of TFTs 74, and an array of storage capacitors 76 connected to the photoelectric conversion layer 72. When radiation is applied to the radiation detector 70, the photoelectric conversion layer 72 generates electric charges, and the storage capacitors 76 store the generated electric charges. Then, the TFTs 74 are turned on one row at a time in order to read the electric charges from the storage capacitors 76 as an image signal. In FIG. 4, the photoelectric conversion layer 72 and one of the storage capacitors 76 are shown as forming a pixel 78, wherein the pixel 78 is connected to one of the TFTs 74. Details of other pixels 78 have been omitted from illustration. Since amorphous selenium tends to change in structure and lose functionality at high temperatures, amorphous selenium needs to be used within a certain temperature range. Therefore, some means for cooling the radiation detector 70 should preferably be provided in the image capturing base.

The TFTs 74 connected to the respective pixels 78 are connected to respective gate lines 80 extending parallel to the rows, and to respective signal lines 82 extending parallel to the columns. The gate lines 80 are connected to a line scanning driver 84, and the signal lines 82 are connected to a multiplexer 86 that serves as a reading circuit.

The gate lines 80 are supplied with control signals Von, Voff for turning on and off the TFTs 74 along the rows from the line scanning driver 84. The line scanning driver 84 comprises a plurality of switches SW1 for switching between the gate lines 80, and an address decoder 88 for outputting a selection signal for selecting one of the switches SW1 at a time. The address decoder 88 is supplied with an address signal from a controller 100.

The signal lines 82 are supplied with electric charges stored in the storage capacitors 76 of the pixels 78 through the TFTs 74 arranged in the columns. The electric charges supplied to the signal lines 82 are amplified by amplifiers 92 connected respectively to the signal lines 82. The amplifiers 92 are connected through respective sample and hold circuits 94 to the multiplexer 86. The multiplexer 86 comprises a plurality of switches SW2 for successively switching between the signal lines 82, and an address decoder 96 for outputting a selection signal for selecting one of the switches SW2 at a time. The address decoder 96 is supplied with an address signal from the controller 100. The multiplexer 86 has an output terminal connected to an A/D converter 98. A radiographic image signal generated by the multiplexer 86 based on the electric charges from the sample and hold circuits 94 is converted by the A/D converter 98 into digital image signals representing the radiographic image information, which are supplied to the communication device 102. The communication device 102 supplies the acquired radiographic image information through the wireless LAN 18 to either one of the first through third consoles 14A through 14C.

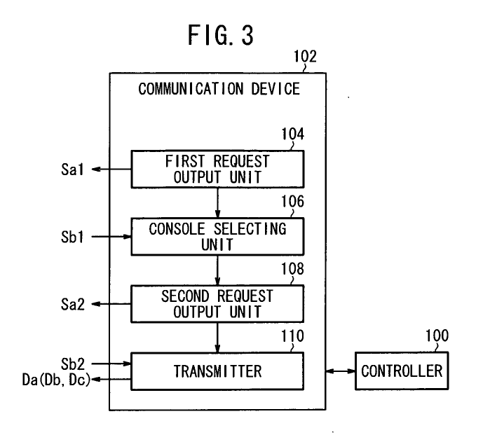

As shown in FIG. 3, the communication device 102 establishes a communication link with one console from among the first through third consoles 14A through 14C, and transmits the obtained radiographic image information through the established communication link to the one console.

More specifically, the communication device 102 includes a first request output unit 104 for transmitting to the first through third consoles 14A through 14C a first request signal Sa1 for requesting image processing prior to the transmission of radiographic image information Da, a console selecting unit (selection device) 106 for selecting one console from among the one or more consoles that have transmitted a first answer signal Sb1 in response to the first request signal Sa1, a second request output unit 108 for transmitting a second request signal Sa2 for requesting establishment of a communication link with respect to the selected one console, and a transmitter (transmitting unit) 110 for transmitting to the selected one console radiation image information Da, upon receipt of the second answer signal Sb2 in response to the second request signal Sa2, which was transmitted from the selected one console. Upon transmission thereof, the transmitter 110 adds an error detecting/correction code Db and an ID code Dc for an image capturing apparatus to the radiation image information Da.

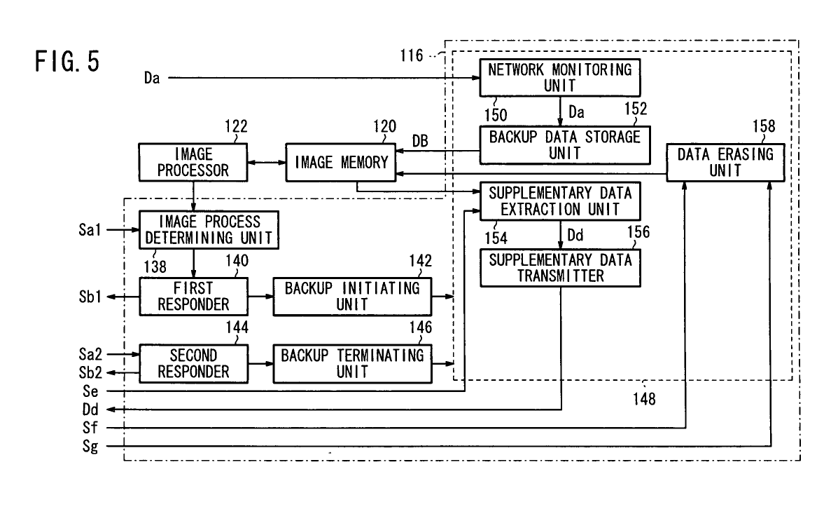

The first through third consoles 14A through 14C each include therein an image processing system 112 and an error correction processing system 114, as shown in FIG. 4, together with a backup processing system 116, as shown in FIG. 5.

As shown in FIG. 4, the image processing system 112 comprises a specification information acceptor 118 for sending the received ID code Dc of an image capturing apparatus to the host computer 22, and for accepting specification information Sd corresponding to the ID code Dc of the image capturing apparatus from the host computer 22, an image memory 120 for storing the received radiographic image information Da, an image processor 122 for performing an image processing process depending on the accepted specification information Sd concerning the radiographic image information Da stored in the image memory 120, and an image transmitter (image transmitting unit) 124 for sending processed radiographic image information dDa along with the ID code Dc of the image capturing apparatus to the host computer 22. As for the specified image processing, if a tomosynthesis image capturing process is carried out, then the image processing process may also be a process for processing a number of items of radiographic image information Da in order to reconstruct a tomographic image of a region of interest, whereas if an energy subtraction image capturing process is carried out, then the image processing process may be a process for performing a subtracting process on two items of radiographic image information Da in order to generate an energy subtraction image or a correction process with respect to radiographic image information Da. The processed radiographic image information dDa, which is sent to the host computer 22, also is sent to the viewer 28 through the wired LAN 20. The doctor then interprets for diagnosis the radiographic image displayed by the viewer 28 based on the radiographic image information dDa. Each of the first through third consoles 14A through 14C may include a display unit for displaying both the unprocessed radiographic image information Da as well as the processed radiographic image information dDa.

The error correction processing system 114, as shown in FIG. 4, includes an error correcting unit 126 for detecting a lost portion of data of the radiographic image information Da recorded in the image memory 120 and for carrying out error correction, a data supplementing request unit 128 for detecting an address of the lost data in the event that correction of the error cannot be handled in the error correcting unit 126 and transmitting the address along with a data supplementing request signal Se to another console, a reception completion notifying unit 130 for transmitting a reception completion signal Sf, based on reception of supplementary data De from the other console, to the transmission source of the supplementary data De, a data supplementing unit 132 for initiating the error correcting unit 126 after the lost portion of the data from the radiographic image information Da has been supplemented based on the received supplementary data De, an image processing initiating unit 134 for initiating the image processor 122 in the event that no lost portion of the data is detected in the error correcting unit 126, and an image processing completion notifying unit 136 for outputting an image processing completion signal Sg at a stage when the specified image processing with respect to the radiographic image information Da has been completed by the image processor 122. The address, which is detected by the data supplementing request unit 128, may be defined by a portion (row address, column address) of the radiographic image information, or an order or sequence of the radiographic image information Da or the like.

The backup processing system 116, as shown in FIG. 5, has an image process determining unit 138 for determining, based on reception of the first request signal Sa1, whether or not image processing can be performed, i.e., whether the image processor 122 is currently performing an operation or not, a first responder 140 for sending the first answer signal Sb1 to the transmission source of the first request signal Sa1 if the image processor 122 is not currently performing an operation, i.e., if image processing is possible, a backup initiating unit 142 for initiating the backup unit 148 based on transmission of the first answer signal Sb1, a second responder 144 for transmitting a second answer signal Sb2 to the transmission source of the second request signal Sa2 if the second request signal Sa2 has been received, and a backup terminating unit 146 for forcibly terminating the backup unit 148 in the event that the second request signal Sa2 has been received.

As shown in FIG. 5, the backup unit 148 includes a network monitoring unit 150 that monitors the wireless LAN 18 and reads in the radiographic image information Da during transmission thereof via the wireless LAN 18, a backup data storage unit 152 for temporarily storing in an image memory 120 the read in radiographic image information Da as backup data DB, a supplementary data extraction unit 154 for extracting as supplementary data Dd all of the backup data DB, or an object portion (a portion that corresponds to the address contained in the data supplementing request signal Se) among the backup data DB, which is stored in the image memory 120, based on reception of the data supplementing request signal Se from one console, a supplementary data transmitter (supplementary data transmitting unit) 156 for transmitting the extracted supplementary data Dd to the transmission source of the data supplementing request signal Se, and a data erasing unit 158, which, after the supplementary data Dd has been sent, waits for a response from the transmission destination (i.e., console) of the supplementary data Dd, e.g., waits for arrival of a reception completion signal Sf or an image processing completion signal Sg, and then erases the backup data stored temporarily in the memory.

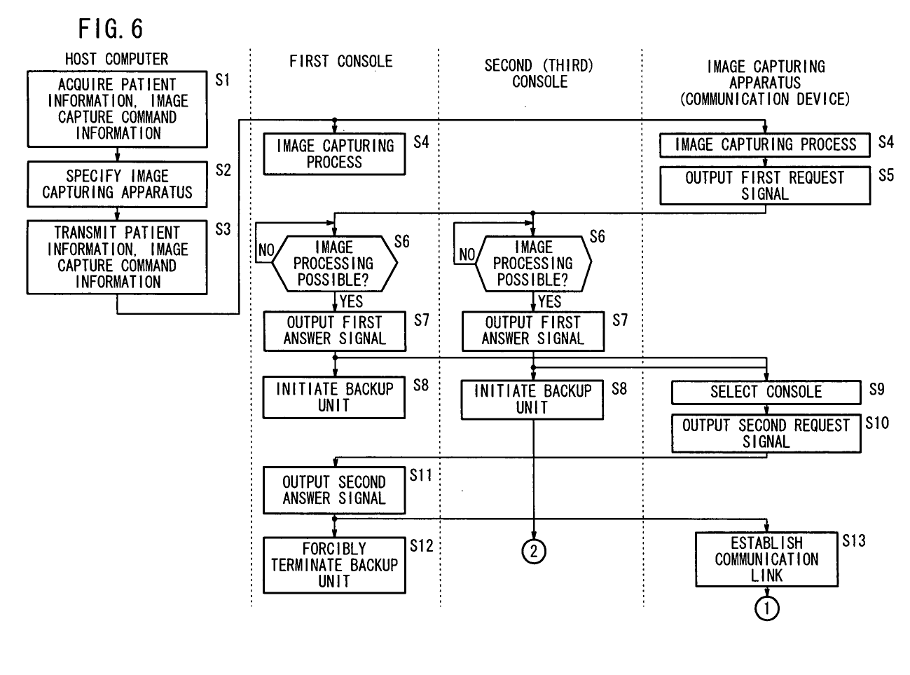

Operations of the first network system 10A will be described below with reference to FIGS. 6 through 8.

As shown in FIG. 6, in step S1, the host computer 22 acquires patient information and image capture command information. Specifically, patient information including the name, age, gender, etc., of a patient is set using the HIS 24, and image capture command information including a radiographic image capturing method, a region to be imaged, and an image capturing apparatus to be used for the patient, is set in relation to the patient information using the RIS 26. The host computer 22, which is installed in the radiological department of the hospital, acquires the patient information and the image capture command information from the RIS 26 via the wired LAN 20.

Then, in step S2, the host computer 22 specifies one, e.g., the first image capturing apparatus 12A, from among the first through third image capturing apparatus 12A through 12C, which corresponds to the patient information and the image capture command information. Then, in step S3, the patient information and image capture command information is transmitted to the console (e.g., the first console 14A) that corresponds to the specified image capturing apparatus. For ease of understanding, in the following explanations, the selected image capturing apparatus shall be referred to as the “first image capturing apparatus 12A”, whereas the console corresponding to the first image capturing apparatus 12A shall be referred to as the “first console 14A”.

Thereafter, in step S4, the first console 14A, to which the patient information and the image capture command information has been sent, carries out a process to capture a radiographic image of the patient using the first image capturing apparatus 12A under the control of the first console 14A, according to the image capture command information.

A specific process for capturing a radiographic image of the subject 50, which is carried out by the first image capturing apparatus 12A under the control of the first console 14A, will be described below with reference to FIG. 1. When the first console 14A receives patient information and image capture command information from the host computer 22, the first console 14A sets a tube voltage, a tube current, and a radiation applying time, which are represented by the image capturing conditions included in the image capture command information, in the radiation source controller 66 of the first image capturing apparatus 12A.

After the subject 50 has been positioned in a prescribed position on the image capturing base, the radiological technician operates an exposure switch (not shown) to begin the radiographic image capturing process. The radiation source controller 66 controls the radiation source 64 according to the image capturing conditions set therein, so as to apply radiation X to the subject 50. Radiation X, which has passed through the subject 50, irradiates the radiation detector 70.

The radiation X is converted into electric signals by the photoelectric conversion layer 72 of the pixels 78 of the radiation detector 70 (see FIG. 2). The electric signals are stored as electric charges in the storage capacitors 76. The stored electric charges, which represent radiographic image information of the subject 50, are read from the storage capacitors 76 according to address signals, which are supplied from the controller 100 to the line scanning driver 84 and the multiplexer 86.

More specifically, in response to the address signal supplied from the controller 100, the address decoder 88 of the line scanning driver 84 outputs a selection signal to select one of the switches SW1, which supplies the control signal Von to the gates of the TFTs 74 connected to the gate line 80 corresponding to the selected switch SW1. In response to the address signal supplied from the controller 100, the address decoder 96 of the multiplexer 86 outputs a selection signal to successively turn on the switches SW2 to switch between the signal lines 82, for thereby reading through the signal lines 82 the electric charges stored in the storage capacitors 76 of the pixels 78 connected to the selected gate line 80.

The electric charges read from the storage capacitors 76 of the pixels 78 connected to the selected gate line 80 are amplified by the respective amplifiers 92, sampled by the sample and hold circuits 94, and supplied to the multiplexer 86. Based on the supplied electric charges, the multiplexer 86 generates and supplies a radiographic image signal to the A/D converter 98, which converts the radiographic image signal into digital signals.

Similarly, the address decoder 88 of the line scanning driver 84 successively turns on the switches SW1 to switch between the gate lines 80 according to the address signal supplied from the controller 100. The electric charges stored in the storage capacitors 76 of the pixels 78 connected to the successively selected gate lines 80 are read through the signal lines 82, and processed by the multiplexer 86 and the A/D converter 98 into digital signals.

The radiographic image information represented by the digital signals is transmitted, via the communication device 102, to any one of the consoles from among the first through third consoles 14A through 14C.

More specifically, returning to explanation of the flowchart of FIG. 6, first, in step S5, the first request output unit 104 (see FIG. 3) of the communication device 102 of the first image capturing apparatus 12A sends a first request signal Sa1 for requesting image processing to the first through third consoles 14A through 14C.

In step S6, the image process determining unit 138 (see FIG. 5) of each of the first through third consoles 14A through 14C determines whether image processing can be performed by the corresponding console, i.e., whether the image processor 122, thereof is currently performing an operation or not, based on input of the first request signal Sa1 from the first image capturing apparatus 12A. Consoles for which it is determined that the image processor 122 is in the midst of carrying out operations are determined as being incapable of performing image processing, and it is waited until the operations of the image processor 122 are completed.

A console for which it is determined that the image processor 122 is not currently under operation is judged as being capable of performing image processing, whereupon the console proceeds to carry out the next process. For example, if the first through third consoles 14A through 14C all are judged to be capable of performing image processing, the first through third consoles 14A through 14C proceed to step S7, and the first responder 140 (see FIG. 5) of each of the first through third consoles 14A through 14C transmits the first answer signal Sb1 to the transmission source (the first image capturing apparatus 12A according to this example) of the first request signal Sa1. Further, in step S8, the backup initiating unit 142 (see FIG. 5) initiates the backup unit 148 based on transmission of the first answer signal Sb1. As noted above, if the first through third consoles 14A through 14C all are capable of performing image processing, first answer signals Sb1 are output respectively to the first image capturing apparatus 12A from each of the first through third consoles 14A through 14C, accompanied by the backup units 148 being initiated respectively in each of the first through third consoles 14A through 14C.

In step S9, the console selecting unit 106 (see FIG. 3) of the communication device 102 that has received the first answer signals Sb1 selects one of the consoles from among the first through third consoles 14A through 14C that transmitted the first answer signal Sb1. This selection may be carried out in accordance with a given console order, which is registered in a first priority table set up beforehand, for example. The following explanations shall be made on the assumption that the console selecting unit 106 has selected the first console 14A, for example.

Thereafter, in step S10, the second request output unit 108 of the communication device 102 (see FIG. 3) outputs the second request signal Sa2 for requesting establishment of a communication link with one console (e.g., the first console 14A) that was selected.

In step S11, the second responder 144 (see FIG. 5) of the first console 14A, which was selected as described above, transmits a second answer signal Sb2 to the transmission source (e.g., the first image capturing apparatus 12A) of the second request signal Sa2, based on input thereto of the second request signal Sa2 from the first image capturing apparatus 12A. Along therewith, in step S12, the backup terminating unit 146 forcibly terminates the backup unit 148.

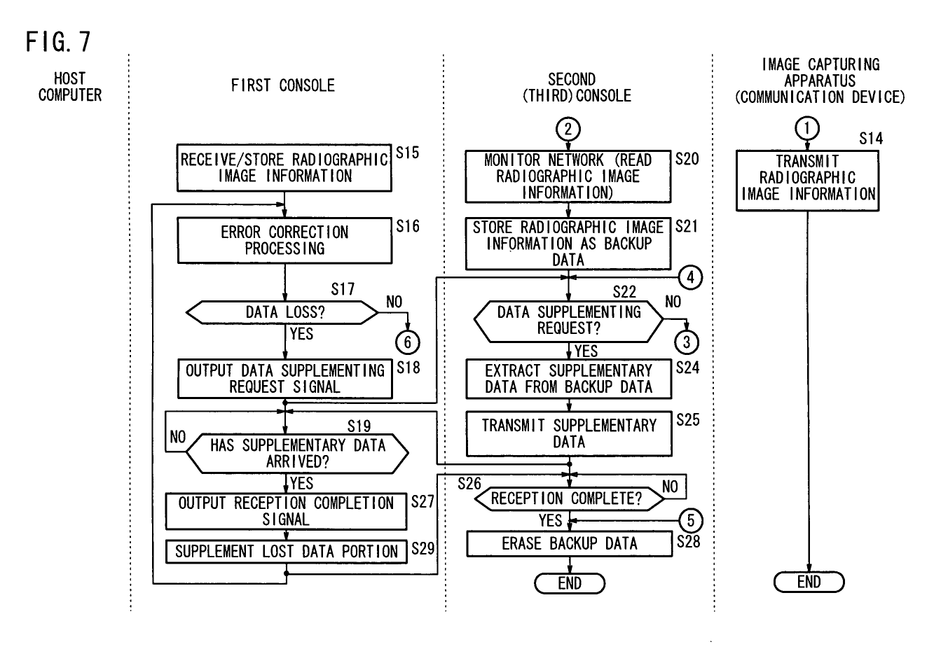

In addition, at a point in time when the second answer signal Sb2, which was transmitted from the first console 14A, is received by the communication device 102 of the first image capturing apparatus 12A, a communication link is established between the first image capturing apparatus 12A and the first console 14A (step S13). Thereafter, in step S14 of FIG. 7, the transmitter 110 of the communication device 102 of the first image capturing apparatus 12A (see FIG. 3) appends an image capturing apparatus ID code Dc and an error detecting/correction code Db to the digitally converted radiographic image information Da, and transmits the same to the first console 14A via the established communication link. By means of this transmission process, at this time, one item of radiographic image information Da is transmitted to the first console 14A in an ordinary radiographic image capturing process (which is neither a tomosynthesis image capturing process nor an energy subtraction image capturing process). Further, several tens of items of radiographic image information Da are transmitted to the first console 14A in the tomosynthesis image capturing process, whereas two items of radiographic image information Da are transmitted to the first console 14A in the energy subtraction image capturing process.

In step S15, the first console 14A receives the radiographic image information Da, etc., from the first image capturing apparatus 12A, and from among such information, stores the radiographic image information Da and the detecting/correction code Db in the image memory 120. The ID code Dc of the image capturing apparatus is stored in a different non-illustrated memory, for example, a register or data memory or the like. By means of such storage processing to the image memory 120, one item of radiographic image information Da is stored in an ordinary radiographic image capturing process. Further, several tens of items of radiographic image information Da are stored in the tomosynthesis image capturing process, whereas two items of radiographic image information Da are stored in the energy subtraction image capturing process.

Thereafter, in step S16, the error correcting unit 126 (see FIG. 4) detects a lost data portion of the radiographic image information Da that is stored in the image memory 120, and carries out error correction thereon. Along therewith, in step S17, it is determined whether or not there exists any data loss which cannot be error corrected in the error correcting unit 126.

As for reasons why there might be generated data loss which cannot be error corrected, when the radiographic image information is transmitted wirelessly from the first image capturing apparatus to the first console, as a result of the radiation source or some other obstacle being moved and passing between the first image capturing apparatus and the first console, the communication environment changes. In such a case, it is easy for data loss to occur.

In data that is highly correlated such as radiographic image information, with respect to random errors in which errors are generated independently and sporadically, error corrections can be carried out responsive to such errors using the values of pixels in the vicinity thereof. However, in the case that loss of data occurs over a wide area, as in the case of burst errors, a problem occurs in that correction of such errors cannot be made. Consequently, according to the present embodiment, by monitoring the network in other consoles, which are installed at locations positionally separated from each other, radiographic image information obtained in a consoles that exists in a region where the communications environment has not changed substantially can be used as backup data, and owing thereto, supplementing of data can easily be carried out.

In addition, in the case of data loss which cannot be corrected, the routine proceeds to the subsequent step S18, whereupon the data supplementing request unit 128 (see FIG. 4) detects an address of the lost portion of data, and transmits the address together with a data supplementing request signal Se to one console (for example, the second console 14B) from among the other consoles (the second and third consoles 14B, 14C in this case). Selection of the one console may be carried out in accordance with a given console order, which is registered in a second priority table set up beforehand, for example.

Thereafter, in step S19, the data supplementing request unit 128 waits for arrival of the supplementary data De from the other console.

On the other hand, in each of the backup units 148 of the second and third consoles 14B and 14C, which have not received the second request signal Sa2, the following processes are carried out.

First, in step S20 of FIG. 7, the network monitoring unit 150 (see FIG. 5) monitors the wireless LAN 18, and reads in the radiographic image information Da (i.e., the radiographic image information Da sent from the first image capturing apparatus 12A to the first console 14A) during transmission thereof via the wireless LAN 18.

In step S21, the backup data storage unit 152 (see FIG. 5) temporarily stores the read in radiographic image information Da in the image memory 120 as backup data DB. One item of radiographic image information Da is stored in an ordinary radiographic image capturing process. Further, several tens of items of radiographic image information Da are stored in the tomosynthesis image capturing process, whereas two items of radiographic image information Da are stored in the energy subtraction image capturing process.

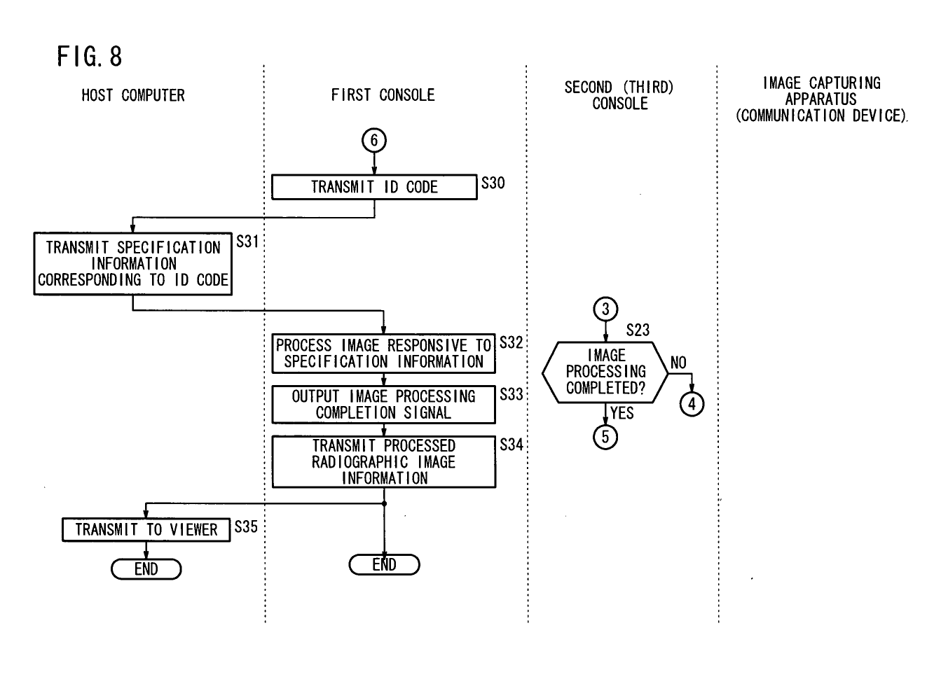

In the next step S22, the backup unit 148 determines whether or not there is a data supplementing request from the other consoles. This determination is carried out depending on whether a data supplementing request signal Se has been received. In the case that a data supplementing request signal Se is not received, the routine proceeds to step S23 of FIG. 8, whereupon the backup unit 148 determines whether or not a notification has been issued from the other consoles indicating completion of data processing. This determination is carried out depending on whether an image processing completion signal Sg (see FIG. 5) has been received. In the case that an image processing completion signal Sg is not received, the determination processing step S22 of FIG. 7 and/or the determination processing step S23 of FIG. 8 are repeated.

In addition, in step S22 of FIG. 7, in the case it is determined that there is a data supplementing request, the routine proceeds to step S24, whereupon the supplementary data extraction unit 154 extracts as supplementary data Dd all of the backup data DB, or an object portion (a portion that corresponds to the address contained in the data supplementing request signal Se) from among the backup data DB, which is stored in the image memory 120. One item of radiographic image information Da, or a portion indicated by the address from among the one item of radiographic image information Da, is extracted as supplementary data Dd in an ordinary radiographic image capturing process. Further, radiographic image information Da of each sequence (1st, 12th, etc.) indicated by addresses, or portions indicated respectively by addresses from among radiographic image information Da of each sequence indicated by the addresses, are extracted as supplementary data Dd in the tomosynthesis image capturing process, whereas radiographic image information Da of a sequence (1st and/or 2nd) indicated by addresses, or portions indicated respectively by addresses from among the radiographic image information Da of sequences indicated by the addresses, are extracted as supplementary data Dd in the energy subtraction image capturing process.

Thereafter, in step S25, the supplementary data transmitter 156 (see FIG. 5) transmits the extracted supplementary data Dd to the transmission source (the first console 14A in this example) of the data supplementing request signal Se.

Thereafter, in step S26, the backup unit 148 waits for arrival of a reception completion signal Sf from the transmission source of the data supplementing request signal Se.

In the first console 14A, in the aforementioned step S19, at a stage when the supplementary data has arrived, the routine proceeds to step S27, whereupon the reception completion notifying unit 130 (see FIG. 4) transmits the reception completion signal Sf to the transmission source of the supplementary data Dd (the second console 14B or the third console 14C, according to this example).

Accordingly, based on reception of the reception completion signal Sf, the backup unit 148 of the second console 14B proceeds to step S28. In step S28, the data erasing unit 158 (see FIG. 5) of the backup unit 148 erases the backup data DB, which was temporarily stored in the image memory 120.

Thereafter, in the first console 14A, in step S29, the data supplementing unit 132 (see FIG. 4) initiates the error correcting unit 126 after having supplemented the lost data portion of the radiographic image information Da based on the received supplementary data. More specifically, the processes of the aforementioned step S16 and thereafter are repeated, whereupon once again, in step S17, in the event a data loss is determined to exist which cannot be error corrected, by means of the data supplementing request unit 128, the address of the lost data portion is detected, whereupon this address together with a data supplementing request signal Se is transmitted to a different one of the consoles (for example, the third console 14C) from among the other consoles. Thereafter, step S18, step S19 and steps S22 through S29 are repeated, whereby the supplementary data Dd is acquired from the third console 14C, and a data supplementing process is carried out.

Additionally, in step S17, at a stage when it is determined that no data loss exists which cannot be error corrected, the routine proceeds to step S30, whereupon the specification information acceptor 118 (see FIG. 4) transmits the received ID code Dc of the image capturing apparatus to the host computer 22. In the host computer 22, specification information Sd that corresponds to the received image capturing apparatus ID code Dc is read out, and is transmitted to the transmission source of the image capturing apparatus ID code Dc (the first console 14A in this example).

In step S32, the image processor 122 of the first console 14A (see FIG. 4) performs image processing corresponding to the received specification information Sd with respect to the radiographic image information Da, following error correction thereof, which is stored in the image memory 120.

Thereafter, in step S33, the image processing completion notifying unit 136 (see FIG. 4) outputs an image processing completion signal Sg at a stage when the specified image processing with respect to the radiographic image information has been completed by the image processor 122.

Thereafter, in step S34, the image transmitter 124 (see FIG. 4) sends the processed radiographic image information dDa along with the ID code Dc of the image capturing apparatus to the host computer 22.

In step S35, the processed radiographic image information dDa, which was sent to the host computer 22, also is sent to the viewer 28 through the wired LAN 20. The doctor then interprets for diagnosis the radiographic image displayed by the viewer 28.

On the other hand, in the aforementioned step S23 of FIG. 8, the second console 14B and the third console 14C, at a stage when the image processing completion signal has been received, proceed to step S28 of FIG. 7, whereupon the data erasing unit 158 of the backup unit 148 (see FIG. 5) erases the backup data DB that was stored temporarily in the image memory 120.

In the foregoing manner, in the first network system, even if data loss occurs during transmission of the radiographic image information, supplementing of such data can easily be carried out, and in addition, without requiring a memory means (e.g., a hard disk or the like) to be newly installed especially for backup purposes, high quality radiographic image information can be obtained at a low cost.

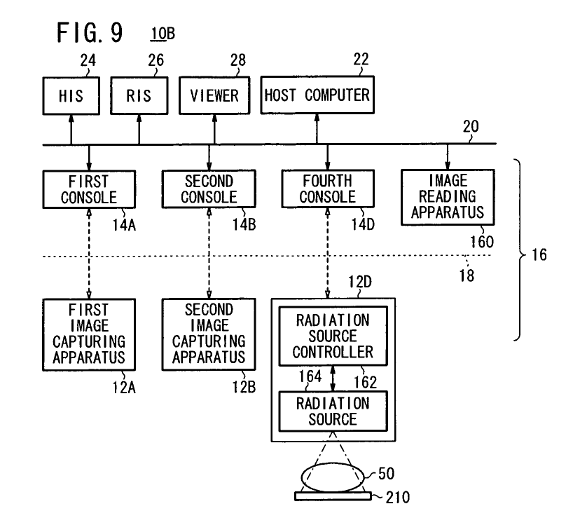

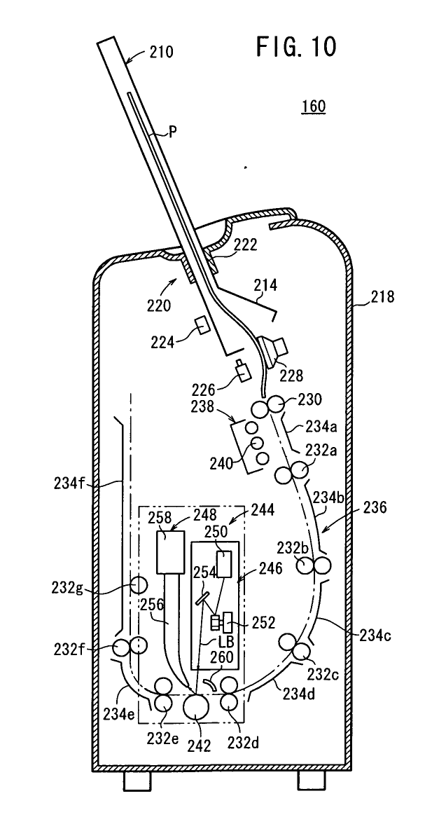

Next, a radiography network system according to a second embodiment (hereinafter referred to as a second network system 10B) will be described below with reference to FIGS. 9 and 10.

As shown in FIG. 9, the second network system 10B is substantially similar in configuration to the first network system 10A, but differs therefrom in that the second network system 10B includes a fourth console 14D, a fourth image capturing apparatus 12D, and an image reading apparatus 160 for reading radiographic image information Da captured by the fourth image capturing apparatus 12D, all of which are connected to the wireless LAN 18, instead of the third console 14C and the third image capturing apparatus 12C. The fourth console 14D and the image reading apparatus 160 also are connected to the wired LAN 20.

The fourth image capturing apparatus 12D is a recumbent image capturing apparatus for capturing a radiographic image of a wide area, e.g., the chest or the like, of a subject 50. The fourth image capturing apparatus 12D comprises a radiation source 164 controlled by a radiation source controller 162, and an image capturing bed disposed in confronting relation to the radiation source 164. The image capturing bed has a slot (not shown) defined in a side wall thereof, for example, for inserting a cassette 210, which houses a stimulable phosphor panel P therein (see FIG. 10). The radiation source controller 162 controls the radiation source 164 according to image capturing conditions set by the fourth console 14D.

The stimulable phosphor panel P comprises a stimulable phosphor layer for storing the energy of radiation X applied thereto, and a support on which the stimulable phosphor layer is disposed. When the stimulable phosphor panel P is irradiated with stimulating light, the stimulable phosphor panel P emits stimulated light the intensity of which is proportional to the stored energy. After the stimulable phosphor panel P has emitted stimulated light, any remaining energy left in the stimulable phosphor panel P can be removed when the stimulable phosphor panel P is irradiated with a given amount of erasing light, thereby enabling the stimulable phosphor panel P to be reused.

Radiographic image information Da recorded in the stimulable phosphor panel P is read by the image reading apparatus 160, which has a structure as shown in FIG. 10. The image reading apparatus 160 and the fourth image capturing apparatus 12D are controlled by the fourth console 14D.

As shown in FIG. 10, the image reading apparatus 160 includes a cassette loader 220 disposed in an upper portion of a casing 218, and a display panel 223 also disposed in the upper portion of the casing 218, for displaying information required in an image reading process carried out by the image reading apparatus 160. The cassette loader 220 has a loading slot 222 for receiving a cassette 210, which houses therein a stimulable phosphor panel P with recorded radiographic image information. Near the loading slot 222, the casing 218 accommodates therein a bar-code reader 224 for reading identification information recorded in a bar code on the cassette 210, an unlocking mechanism 226 for unlocking a lid 214 of the cassette 210, a suction cup 228 for attracting and removing the stimulable phosphor panel P from the cassette 210 when the lid 214 is opened, and a pair of nip rollers 230 for gripping and feeding the stimulable phosphor panel P removed by the suction cup 228.

The nip rollers 230 are followed by a plurality of feed rollers 232a through 232g and a plurality of guide plates 234a through 234f, which jointly make up a curved feed path 236. The curved feed path 236 extends downwardly from the cassette loader 220, extends substantially horizontally at a lowermost portion thereof, and then extends substantially vertically upward. A curved feed path 236 of this shape is effective in making the image reading apparatus 160 small in size.

An erasing unit 238 is disposed between the nip rollers 230 and the feed rollers 232a, for erasing radiographic image information remaining in the stimulable phosphor panel P, from which desired radiographic image information has already been read. The erasing unit 238 has a plurality of erasing light sources 240 such as cold cathode-ray tubes or the like for emitting erasing light.

A platen roller 242 is disposed between the feed rollers 232d, 232e, which are positioned in the lowermost portion of the curved feed path 236. The platen roller 242 is disposed beneath a scanning unit 244 for reading desired radiographic image information recorded in the stimulable phosphor panel P.

The scanning unit 244 comprises a stimulator 246 for emitting a laser beam LB as stimulating light to scan the stimulable phosphor panel P, and a reader 248 for reading stimulated light emitted from the stimulable phosphor panel P, which is stimulated by the laser beam LB.

The stimulator 246 comprises a laser oscillator 250 that outputs the laser beam LB, a rotary polygon mirror 252 for deflecting the laser beam LB in a main scanning direction across the stimulable phosphor panel P, and a reflecting mirror 254 for reflecting the laser beam LB toward the stimulable phosphor panel P as the stimulable phosphor panel P passes over the platen roller 242.

The reader 248 comprises a light guide 256 having a lower end disposed near the stimulable phosphor panel P over the platen roller 242, and a photomultiplier 258 connected to an upper end of the light guide 256, for converting stimulated light from the stimulable phosphor panel P into an electric signal, which represents the radiographic image information stored in the stimulable phosphor panel P. A light collecting mirror 260 for collecting stimulated light from the stimulable phosphor panel P is disposed near the lower end of the light guide 256. The photomultiplier 258 supplies an electric signal representing the radiographic image information to the host computer 22 via the wired LAN 20.

As with the first through third consoles 14A through 14C, each of the fourth console 14D and the image reading apparatus 160 includes therein the image processing system 112, the error correction processing system 114, and the backup processing system 116.

In the second network system 10B thus constructed, similar to the aforementioned first network system 10A, even if data loss occurs during transmission of the radiographic image information Da, supplementing of such data can easily be carried out, and in addition, without requiring a memory means (e.g., a hard disk or the like) to be newly installed especially for backup purposes, high quality radiographic image information can be obtained at a low cost.

In the above-described example, the data erasing unit 158 waits until a response from the transmission destination (console) of the supplementary data Dd, for example a reception completion signal Sf or the image processing completion signal Sg, arrives, and then is operated to erase the backup data that is stored temporarily in the memory. However, apart therefrom, the backup data may also be erased after a fixed time period has been maintained, until diagnosis and treatment on a given day of capturing images have been completed. The data erasing unit 158 may be omitted.

The radiation detector 70 according to the first embodiment is of the direct conversion type, which directly converts the dose of applied radiation X into an electric signal with the photoelectric conversion layer 72. However, each of the image capturing apparatus may employ a radiation detector of an indirect conversion type including a scintillator for converting the applied radiation X into visible light, and a solid-state detecting device made up of amorphous silicon (a-Si) or the like for converting the visible light into electric signals (see Japanese Patent No. 3494683).

Although certain preferred embodiments of the present invention have been shown and described in detail, it should be understood that various changes and modifications may be made to the embodiments without departing from the scope of the invention as set forth in the appended claims.

What is claimed is:

1. A radiography network system, which is equipped with a radiographic image capturing system having at least a plurality of image capturing apparatus for detecting radiation that has passed through a subject in a radiographic image capturing process and converting the radiation into radiographic image information, and a plurality of controllers for controlling the image capturing apparatus based on image capture command information supplied from the exterior, at least the plurality of image capturing apparatus and the plurality of controllers of the radiographic image capturing system being interconnected over a wireless network, wherein:
a portion or all of the plurality of image capturing apparatus each include respectively a communication device for establishing a communication link with one of the controllers from among the plurality of controllers, and transmitting the obtained radiographic image information to the one controller;
the plurality of controllers each include respectively a backup unit therein, which is operated in the case that the communication link is not established;
the backup unit comprising:
a unit for monitoring the network, reading the radiographic image information during transmission thereof via the network, and temporarily storing the read radiographic image information as backup data; and
a unit for transmitting a portion or all of the backup data to the one controller as supplementary data in accordance with a data supplementing request from the one controller.

2. The radiography network system according to claim 1, wherein the backup unit further comprises:
a network monitoring unit for monitoring the network and reading the radiographic image information during transmission thereof via the network;
a backup data storage unit for temporarily storing the read radiographic image information in a memory as backup data;
a supplementary data extraction unit for extracting as supplementary data all of the backup data that is stored in the memory, or an object part of the data supplementing request from among the backup data, based on the data supplementing request from the one controller; and
a supplementary data transmitting unit for transmitting the extracted supplementary data to the one controller.

3. The radiography network system according to claim 1, wherein the radiographic image capturing system further comprises:
a plurality of image capturing apparatus, which each utilize a radiation detector for detecting radiation that has passed through a subject in a radiographic image capturing process and converting the radiation into radiographic image information, and a plurality of controllers for controlling the image capturing apparatus based on image capture command information supplied from the exterior,
wherein the plurality of image capturing apparatus and the plurality of controllers are interconnected by a wireless network, and
wherein the plurality of image capturing apparatus each include the communication device therein, respectively.

4. The radiography network system according to claim 1, wherein the radiographic image capturing system further comprises:
at least one first image capturing apparatus utilizing a radiation detector that detects radiation having passed through a subject in a radiographic image capturing process and converts the radiation into radiographic image information, at least one second image capturing apparatus utilizing a stimulable phosphor panel that detects radiation having passed through a subject in a radiographic image capturing process, converts the radiation into radiographic image information and stores the radiographic image information therein, at least one image reading apparatus for reading the radiographic image information from the stimulable phosphor panel, and a plurality of controllers for controlling any of the first image capturing apparatus, the second image capturing apparatus, and the image reading apparatus based on image capture command information supplied from the exterior,
the at least one first image capturing apparatus, the at least one second image capturing apparatus, the at least one image reading apparatus, and the plurality of controllers being interconnected over a wireless network,
wherein each of the at least one first image capturing apparatus includes the communication device therein, respectively, and
wherein each of the plurality of controllers and the at least one image reading apparatus includes the backup unit therein, respectively.

5. The radiography network system according to claim 1, wherein the communication device further comprises:
a first request output unit for transmitting a first request signal for requesting image processing to the plurality of controllers, prior to transmission of the radiographic image information;
a selection device for selecting one controller from among one or more controllers that transmit a first answer signal in response to the first request signal;
a second request output unit for transmitting a second request signal for requesting establishment of a communication link with respect to the one controller that has been selected; and
a transmitting unit for transmitting the radiographic image information to the one controller, upon reception of a second answer signal in response to the second request signal transmitted from the one controller,
wherein an unselected controller, among the one or more controllers that transmit the first answer signal, is caused to operate the backup unit contained therein.

6. The radiography network system according to claim 1, wherein:
in the case there is data loss in the transmitted radiographic image information, the one controller indicates an address where the data loss occurred, and carries out the data supplementing request, and
the backup unit extracts, as the supplementary data, all of the backup data or a portion corresponding to the address from among the backup data, and transmits the supplementary data to the one controller.

7. The radiography network system according to claim 1, wherein the backup unit further comprises a data erasing unit for erasing the backup data after transmission of the supplementary data to the one controller.

8. The radiography network system according to claim 7, wherein the data erasing unit, after having transmitted the supplementary data to the one controller, waits for a response from the one controller before erasing the backup data.

9. The radiography network system according to claim 7, wherein the data erasing unit, after having transmitted the supplementary data to the one controller, erases the backup data based on a reception completion response of the supplementary data from the one controller.

10. The radiography network system according to claim 7, wherein the data erasing unit, after having transmitted the supplementary data to the one controller, erases the backup data based on a data supplementing completion response from the one controller.

11. A radiographic image capturing system control method, for controlling through a wireless network at least a plurality of image capturing apparatus and a plurality of controllers, which constitute a radiographic image capturing system comprising at least the plurality of image capturing apparatus for detecting radiation that has passed through a subject in a radiographic image capturing process and converting the radiation into radiographic image information, and the plurality of controllers for controlling the image capturing apparatus based on image capture command information supplied from the exterior, at least the plurality of image capturing apparatus and the plurality of controllers of the radiographic image capturing system being interconnected over the wireless network, comprising the steps of:
establishing a communication link between a portion or all of the image capturing apparatus and one of the controllers from among the plurality of controllers, and transmitting the obtained radiographic image information to the one controller; and
performing backup processing in the event that the communication link is not established;
the backup processing step further comprising the steps of:
monitoring the network, reading the radiographic image information during transmission thereof via the network, and temporarily storing the read radiographic image information as backup data; and
transmitting a portion or all of the backup data to the one controller as supplementary data in accordance with a data supplementing request from the one controller.
